(19) United States
(12) Patent Application Publication
(10) Pub. No.: US 2023/0345164 A1
(43) Pub. Date: Oct. 26, 2023

(54) Methods And Systems For Active Noise Cancellation Earphone Based Acoustic Sensing

(71) Applicant: Nanyang Technological University, Singapore (SG)

(72) Inventor: Jun LUO, Singapore (SG)

(21) Appl. No.: 18/137,466

(22) Filed: Apr. 21, 2023

(30) Foreign Application Priority Data
Apr. 21, 2022 (SG) 10202204174P

(51) Int. Cl. H04R 1/10; G10K 11/178; G06F 21/32

(52) U.S. Cl. CPC H04R 1/1041; G10K 11/17823; H04R 1/1083; H04R 1/1016; G06F 21/32

(57) ABSTRACT

Methods, computer readable media and systems for acoustic sensing are provided. The system for acoustic sensing includes an acoustic sensing controller configured to receive signals from an active noise cancellation earphone device. The acoustic sensing controller is further configured to process the signals to determine device wearing status acoustic characteristics and actively correct the signals in response to the device wearing status acoustic characteristics, the device wearing status acoustic characteristics including ear canal occlusion.

### PRIORITY CLAIM

This application claims priority from Singapore Patent Application No. 10202204174P filed on 21 Apr. 2022.

### TECHNICAL FIELD

The present invention generally relates to earable acoustic sensing, and more particularly relates to methods and systems for active noise cancellation earphone based acoustic sensing.

### BACKGROUND OF THE DISCLOSURE

In recent years, particular attention has been devoted to earable acoustic sensing due to its numerous applications. However, the lack of a common platform for accessing raw audio samples has forced researchers and developers to pay great efforts to the trifles of prototyping which is often irrelevant to the core sensing functions. Meanwhile, the growing popularity of active noise cancellation has endowed common earphones with high standard acoustic capability yet to be explored by sensing.

Enabling a new modality of hands-free sensing and low intrusive information exchange, earable computing has ushered a revolution to human wearable computing. Though promising progress has been achieved for HCI (human-computer interaction) and context-aware computations, relying on dedicated earable sensors renders them expensive and inflexible, as opposed to leveraging earphones that attracts significant attention recently due to their low-cost and ubiquity. In particular, a recent proposal exploits earphones to sense the difference in air pressure between two ears so as to profile human states and has shown success in recognizing heart rate, touch gestures, identities, and even voices. However, leveraging differential signals only captures part of the original excitation sources, so this design may not be applicable to scenarios demanding fine-grained information.

Meanwhile, as the demand for more natural communication experience and the awareness of noise-induced hearing loss continue to grow, the market share of active noise cancellation (ANC) earphones increases drastically. Given their high-standard in-ear acoustic facilities, they are expected to improve existing earable sensing capabilities significantly. However, proposals claiming to be designed for ANC earphones, such as behavioural analysis, daily health monitoring, and user authentication, are often implemented and tested on self-built prototypes, making their practical effectiveness very questionable. Essentially, the lack of unified access to raw audio samples from ANC earphones is holding back the progress of earable acoustic sensing, repetitive efforts are required in (re-)building hardware prototypes often irrelevant to core sensing algorithms. In a nutshell, whether ANC earphones may open up a new era of wearable sensing or simply stop at being a daily fashion accessory strongly depends on the development of a common sensing platform.

Thus, there is a need for acoustic sensing systems and platforms which overcomes the drawbacks of current earable acoustic sensing device designs and provides a more efficient, more scalable and more universally applicable platform. Furthermore, other desirable features and characteristics will become apparent from the subsequent detailed description and the appended claims, taken in conjunction with the accompanying drawings and this background of the disclosure.

### SUMMARY

According to at least one aspect of the present embodiments, an acoustic sensing system is provided. The system includes an acoustic sensing controller configured to receive signals from an active noise cancellation earphone device. The acoustic sensing controller is further configured to process the signals to determine device wearing status acoustic characteristics and actively correct the signals in response to the device wearing status acoustic characteristics, the device wearing status acoustic characteristics including ear canal occlusion.

According to another aspect of the present embodiments, a method for acoustic sensing is provided. The method includes receiving signals from an active noise cancellation earphone device and processing the signals to determine device wearing status acoustic characteristics. The method further includes actively correcting the signals in response to the device wearing status acoustic characteristics, wherein the device wearing status acoustic characteristics include ear canal occlusion by the active noise cancellation earphone device.

According to yet a further aspect of the present embodiments, a non-transitory computer readable medium for acoustic sensing is provided. The non-transitory computer readable medium has stored thereon software instructions that, when executed by a processor, cause the processor to process signals received from an active noise cancellation earphone device to determine device wearing status acoustic characteristics and actively correct the signals in response to the device wearing status acoustic characteristics, the device wearing status acoustic characteristics including ear canal occlusion by the active noise cancellation earphone device.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with present embodiments.

FIG. 1 depicts an illustration of use of an acoustic sensing platform in accordance with present embodiments.

FIG. 2, comprising FIGS. 2A to 2D, depicts graphs of measurements of device wearing states on three acoustic sensing applications by the acoustic sensing platform in accordance with the present embodiments used with active noise cancelling (ANC) earphones, wherein FIG. 2A depicts measurements when the ANC earphones are shallowly inserted into the ear canal, FIG. 2B depicts measurements when the ANC earphones are deeply inserted into the ear canal, FIG. 2C depicts measurements when the ANC earphones are superficially inserted into the ear canal, and FIG. 2D depicts measurements when the ANC earphones are best fit in the ear canal.

FIG. 3, comprising FIGS. 3A to 3D, depicts graphs of the effect of diversified interferences to three acoustic sensing application measurements by the acoustic sensing platform in accordance with the present embodiments, wherein FIG. 3A depicts graphs of sensing application measurements when sitting, FIG. 3B depicts graphs of sensing application measurements when nodding, FIG. 3C depicts graphs of sensing application measurements when walking, and FIG. 3D depicts graphs of sensing application measurements when speaking.

FIG. 4, comprising FIGS. 4A to 4C, depicts graphs of acoustic signaling differentiation between two ears as measured by the acoustic sensing platform in accordance with the present embodiments, wherein FIG. 4A depicts graphs of PCG monitoring, FIG. 4B depicts graphs of hand-face interactions, and FIG. 4C depicts graphs of biometric authentication.

FIG. 5 depicts a diagram of the acoustic sensing platform architecture in accordance with the present embodiments.

FIG. 6 depicts a photograph of a system utilizing the acoustic sensing platform in accordance with the present embodiments.

FIG. 7, comprising FIGS. 7A and 7B, depicts electro-acoustic models of the ear canal utilized for design of the acoustic sensing platform in accordance with the present embodiments, wherein FIG. 7A depicts a diagram and a schematic of a perfect occlusion electro-acoustic model and FIG. 7B depicts a diagram and a schematic of a partial occlusion electro-acoustic model.

FIG. 8 depicts a graph of impedance versus frequency for varying insertion depths of a perfectly occluded earphone as measured in accordance with the present embodiments.

FIG. 9, comprising FIGS. 9A and 9B, depicts graphs of body motion interference contaminated PCG signals collected from both ears by the acoustic sensing platform in accordance with the present embodiments, wherein FIG. 9A depicts the left ear and FIG. 9B depicts the right ear.

FIG. 10, comprising FIGS. 10A and 10B, depicts graphs of body motion interference elimination examples in accordance with the present embodiments, wherein FIG. 10A depicts a graph of a demixed interference reference and FIG. 10B depicts a graph of extracted PCG (S₁ and S₂) from both ears.

FIG. 11 depicts a photograph of the acoustic sensing platform in accordance with the present embodiments with ANC earphones in operation.

FIG. 12 depicts a graph of detecting Si and S2 within the PCG signals sensed by the acoustic sensing platform in accordance with the present embodiments and an aligned electrocardiogram (ECG) signal and using a threshold and a smoother envelope to enhance the detected signal by acoustic sensing signal processing in accordance with the present embodiments.

FIG. 13 depicts graphs of PCG signals measured by the acoustic sensing platform in accordance with the present embodiments under four cases and two baselines with body motion interferences highlighted with dotted lines.

FIG. 14 depicts a box plot of performance comparisons of acoustic sensing in accordance with the present embodiments with respect to PCG monitoring and HRV features estimation of the cases and baselines of the graphs of FIG. 13.

FIG. 15, comprising FIGS. 15A and 15B, depicts the hand-face interactive gesture design for testing the efficacy of the acoustic sensing platform in accordance with the present embodiments, where FIG. 15A depicts hand-face tapping gestures and FIG. 15B depicts hand-face sliding gestures.

FIG. 16 depicts gesture-induced waveforms for each of six tapping gestures and each of six sliding gestures detected by the acoustic sensing platform in accordance with the present embodiments.

FIG. 17 depicts a bar graph of performance of hand-face gesture recognition with commonly used classifiers acoustically sensed in accordance with the present embodiments.

FIG. 18, comprising FIGS. 18A to 18D, depicts a procedure of obtaining transfer function and subsequent authentication using the acoustic sensing platform in accordance with the present embodiments, wherein FIG. 18A depicts processing the excitation signal and adding it to the measured signal, FIG. 18B depicts inverse filtering to invert the response to the excitation signal, FIG. 18C depicts matching of a subject against a recorded template for authentication, and FIG. 18D depicts matching a device wearing state (DWS) of a subject for authentication.

And FIG. 19 depicts a bar graph of performance of user authentication by the acoustic sensing platform in accordance with the present embodiments.

Skilled artisans will appreciate that elements in the figures are illustrated for simplicity and clarity and have not necessarily been depicted to scale.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description. It is the intent of present embodiments to present an acoustic sensing platform based on commercial active noise cancellation (ANC) earphones. The acoustic sensing platform in accordance with the present embodiments is a compact design to handle hardware heterogeneity and to deliver flexible control on audio facilities. Leveraging a systematic study on in-ear acoustic signals, the acoustic sensing platform in accordance with the present embodiments provides improved performance sensitivity to device wearing states and reduces body motion interference. Three major acoustic sensing applications are implemented utilizing the acoustic sensing platform in accordance with the present embodiments to evidence its efficacy and adaptability and its promising future in facilitating earable acoustic sensing research.

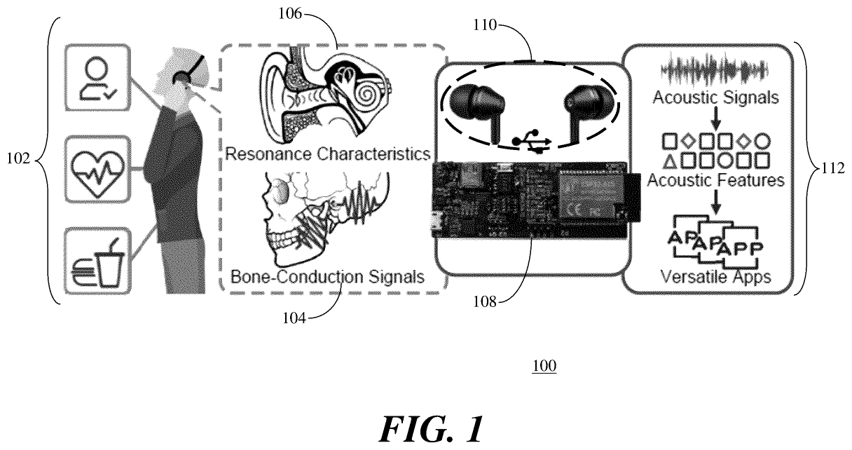

FIG. 1 depicts an illustration 100 of the acoustic sensing platform in accordance with the present embodiments. As shown in FIG. 1, human vitals and activities 102 generate signals 104 propagating to the ears through bones and cause unique ear canal resonance characteristics 106. An acoustic sensing platform 108 in accordance with the present embodiments captures such signals with ANC acoustic facilities 110, i.e., ANC earphones, to enable versatile sensing functionalities. Specifically, the acoustic sensing platform 108 in accordance with the present embodiments aims to enable convenient and unobtrusive sensing. A compact plug-in peripheral, such as the sensing platform 108, is advantageously designed to be readily attachable to arbitrary ANC earphones 110, utilizing the inherent functionalities of the ANC earphones 110 including the native acoustics of the ANC earphones 110 for acoustic sensing. “Native acoustics” refers to devices for the acoustic sensing in the selected ANC earphones 110 such as the microphone originally designed for active noise cancellation and hence built into the ANC earphones 110. The acoustic sensing platform 108 in accordance with the present embodiments utilizes native acoustics of the ANC earphones 110 and advantageously does not require additional microphones or other acoustic sensing equipment. In addition, the acoustic sensing platform 108 in accordance with the present embodiments is designed to allow flexible control and reconfiguration on different acoustic facilities 112. A user-friendly graphic user interface (GUI) advantageously enables a user to select microphones or speakers available to sense or transmit, tune sensor configuration, and enable/disable the ANC function. Also, the acoustic sensing platform 108 in accordance with the present embodiments ensures reliable, dependable measurements. The acoustic sensing platform 108 in accordance with the present embodiments detects fine-grained device wearing state (DWS) to obtain desired signal quality, while eliminating body motion interference, to ensure accurate sensing under practical scenarios.

In order to meet the above requirements, several design strategies for implementing the acoustic sensing platform in accordance with the present embodiments are proposed. First, common features of the audio front-ends are identified to determine a basic platform design, minimizing the adaptations to accommodate hardware heterogeneity. Second, an Android-based control interface is developed in order to mask the nuance of the underlying hardware to enable users to readily configure platform parameters and access sensing data. Third, as DWSs may significantly affect the sensing quality, the acoustic characteristics under different DWSs have been studied to allow development of a quantitative profile of how DWSs are impacted by particular features of an impedance to enable the acoustic sensing platform in accordance with the present embodiments to detect fine-grained DWSs. Finally, to cope with body motions heavily affecting earable sensing quality, the different acoustic characteristics between left and right ears has been investigated; by associating path sensitivity of signals with non-periodicity of interference, the acoustic sensing platform in accordance with the present embodiments is endowed with an interference reference that further warrants an elimination algorithm to ensure reliable sensing in real-life scenarios.

Accordingly, the acoustic sensing platform in accordance with the present embodiments exhibits three main advantages over existing earable platforms. First, it empowers versatile acoustic sensing upon earables with a much wider frequency range than existing developments due to utilization of the native acoustics of the earables. Second, it provides utility functions to ensure reliable sensing measurements, allowing researchers/developers to focus on core sensing algorithms without being troubled by reliability issues. And third, the acoustic sensing platform in accordance with the present embodiments supports a broad range of applications, including both active and passive sensing.

The acoustic sensing platform in accordance with the present embodiments is an acoustic sensing platform leveraging commercial ANC earphones and their native acoustics and thereby aims to enable flexible access to the increasingly popular ANC facility for enhancing in-ear acoustic sensing. In addition, the acoustic sensing platform in accordance with the present embodiments is developed as a plug-in platform with an Android-based control interface to simplify the development of acoustic sensing applications by making laborious hardware-related details transparent to developers. Further, as sensing applications often call for the awareness of DWSs, the acoustic sensing platform in accordance with the present embodiments includes a novel algorithm to identify fine-grained DWSs, so as to improve the sensing qualities of respective applications.

Also, in accordance with the present embodiments, an interference elimination algorithm is proposed which associates path sensitivity of signals with non-periodicity of motion-induced interference in order to extract clean measurements for ensuring reliable acoustic sensing.

As an example of the efficacy and adaptability of the acoustic sensing platform in accordance with the present embodiments, three representative applications (including fine-grained heart sound monitoring very hard to achieve by wearable sensing) are proposed and the promising results indicate that the acoustic sensing platform in accordance with the present embodiments is fully capable of meeting diversified acoustic sensing requirements.

Thus, it can be seen that the acoustic sensing platform in accordance with the present embodiments aims to facilitate the transition from an experiment platform to earable computing-ready ANC earphones, creating an opportunity to push earable computing towards pervasive adoption.

Recently developed earable sensing platforms often have limited applicability as they either lose track of critical information or are restricted to certain frequency ranges. Therefore, in order to gain versatile capabilities in a wider range of acoustic sensing, the acoustic sensing platform in accordance with the present embodiments retains original information from native acoustic sensing by broadening its sensitive spectrum. To this end, opportunities and challenges in versatile sensing via earphone acoustics are investigated by exploring three major categories on human sensing: physiological signal monitoring, activity and behavior analysis, and security and authentication.

As one of the “inlets” into human body, the ear canal offers unique opportunities for acoustic sensing to capture and monitor physiological signals, such as respiration rate, heart rate, and coughing which can be leveraged to detect physiological or pathological states such as sleep stages and diseases. As an example of monitoring physiological signals, the use of the acoustic sensing platform in accordance with the present embodiments as a phonocardiogram (PCG) for acquiring sounds produced by the closure of the heart valves is discussed hereinbelow.

Given their proximity to the human body, earphones allow for close tracking of various body activities and behaviors. Several earable computing applications have succeeded in facial expression recognition, head movement detection, and step counting. Earable acoustic sensing can further advance activity and behavior analysis and, considering that hand-face interactions such as tapping and sliding could generate unique vibrations, a practically usable task of recognizing hand-face interactions which could deliver a new input experience to users is also discussed hereinbelow.

Finally, as earphones are increasingly pervasive in our daily life, they may provide an additional line of security defense for mobile devices by, for example, delivering a stand-alone authentication channel. Ear canal biometrics, such as the static geometry of the ear canal and ear canal deformation due to articulation activities have been explored. Based on the facts that the human ear canal is a closed space consisting of different reflective surfaces and that the acoustic signals reflected by these surfaces encode unique features, the practical application of using earphones to authenticate a user via active acoustic sensing by, for example, playing random content such as music or voice messages as acoustic excitation and sensing the signal reflections as “earprint” is also discussed hereinbelow.

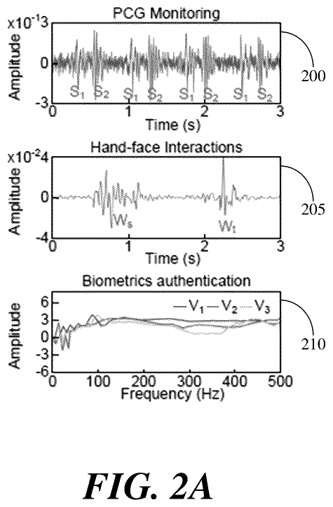

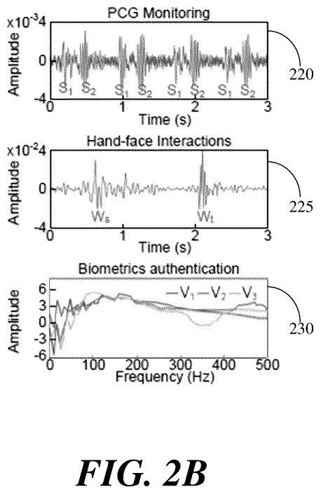

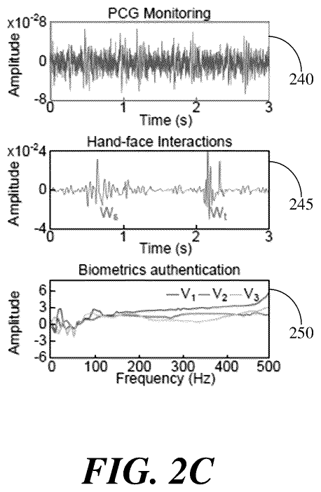

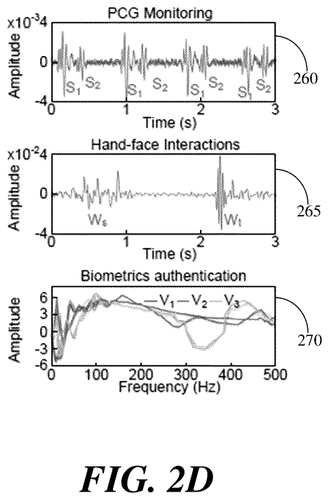

In order to understand the feasibility of using the acoustic sensing platform in accordance with the present embodiments for the three use cases introduced above, it is initially investigated whether earable acoustics are sufficiently sensitive to support the three applications. Specifically, experiments were conducted in a quiet lab and record a PCG signal, the sound of sliding and tapping on the face, and the in-ear reflection of a piece of music to derive a transfer function from music reflections as biometrics were recorded. The results are shown in FIGS. 2A, 2B, 2C and 2D which each depict measurements of device wearing states by the acoustic sensing platform in accordance with the present embodiments as used with active noise cancelling (ANC) earphones for three applications in respective rows. FIG. 2A depicts measurements when the ANC earphones are shallowly inserted into the ear canal, FIG. 2B depicts measurements when the ANC earphones are deeply inserted into the ear canal, FIG. 2C depicts measurements when the ANC earphones are superficially inserted into the ear canal, and FIG. 2D depicts measurements when the ANC earphones are best fit in the ear canal.

Referring to the PCG monitoring graphs 200, 220, 260, it is known that one period of PCG consists of two sounds: S₁ indicates atrioventricular valves closing and S₂ indicates the semilunar valves closing. From the graph 260 (FIG. 2D), it can be clearly observed that the recorded signals successfully capture both S₁ and S₂, showing that in-ear microphones are highly sensitive to such subtle excitation signals. It is also evident from the graph 265 that distinctive signal fluctuations when sliding (denoted by Wₛ) and tapping (denoted by Wₜ) behaviors occur, demonstrating the feasibility for behavior analysis. Finally, from the graph 270 it can be confirmed that the transfer functions of the three individuals (V₁, V₂, V₃) exhibit discernible distinctions, proving that acoustic characteristics are sensitive to the ear canal resonance and can hence be adopted as biometrics. In short, the graphs 260, 265, 270 of FIG. 2D confirm the feasibility of both passively and actively using in-ear acoustics to enable sensing applications.

When placing an object in an ear canal (a small S-shape tube roughly 30 mm in length), the in-ear acoustic characteristics are affected by i) occlusion, ii) occlusion effect, and iii) ear resonance. Occlusion denotes the closure of the ear canal, such as by an earphone as an earplug, causing attenuation of external acoustic signals. Occlusion effect, not to be confused with occlusion, is the self-generated intensification of low-frequency components (<50 Hz) when an ear canal is occluded; a shallow insertion of an earpiece strengthens the occlusion effect. Ear resonance refers to the high-frequency (>100 Hz) amplification associated with an open (or partially open) ear canal, which can be greatly reduced by a deep earpiece insertion. In short, the in-ear acoustic characteristics may vary significantly with the device wearing state (DWS).

The graphs 200, 205, 210 depict a shallow insertion (i.e., with a small vent) DWS, the graphs 220, 225, 230 depict a deep insertion (i.e., completely occluded) DWS, and the graphs 240, 245, 250 depict a superficial insertion (i.e., with a large vent) DWS. Firstly, for PCG monitoring, the two separated heart sounds (S₁ and S₂) are evident under both shallow insertion conditions as seen in the graph 200 and deep insertion conditions as seen in the graph 220, but they become barely recognizable under the superficial insertion condition as seen in the graph 240. The repetitive measurements indicate that interfering sources come from the external environment.

Secondly, for activity analysis as seen in the graphs 205, 225, 245, the on-face sliding and tapping sounds (Wₛ and Wₜ) can always be differentiated regardless of the DWS. This demonstrates that the hand-face interactions collected from ears are less sensitive to the DWS.

Thirdly, for biometric authentication, it can be observed from the graphs 210, 230, 250 that changing the DWS has a significant impact on the transfer function of the ear canal, and that the impact varies from subject to subject. Completely occluding the ear canal as shown in the graphs 230, 270 allows the transfer functions of different subjects to exhibit discernible differences over the frequency ranges of [0, 50] Hz and [300, 500] Hz, whereas the graphs 210, 250 indicate that the shallow insertion and the superficial insertion, respectively, render the transfer functions of all subjects insufficient for identification purposes. In summary, it is often critical to detect the fine-grained DWSs rather than being aware of only putting on and taking off the earphones.

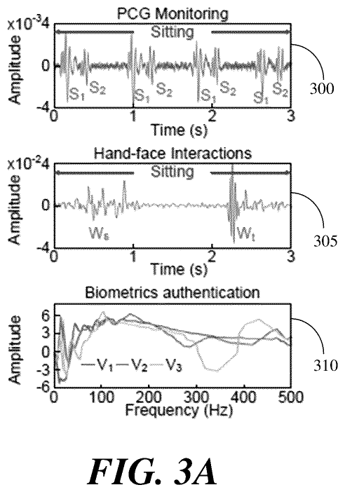

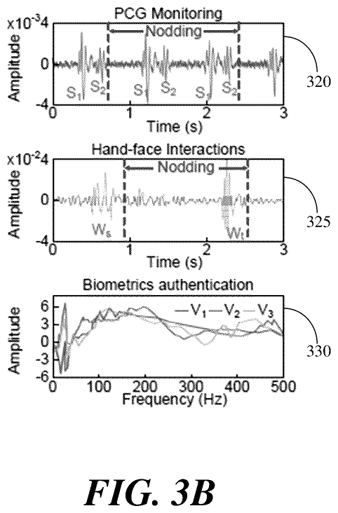

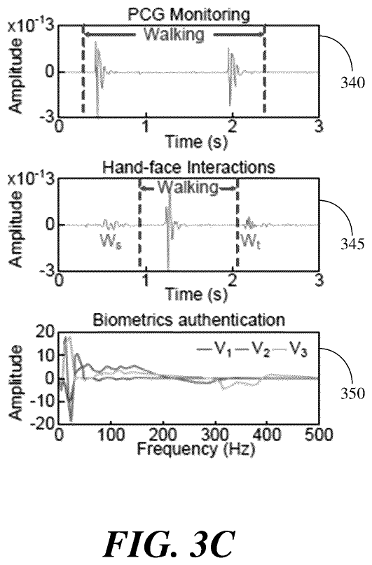

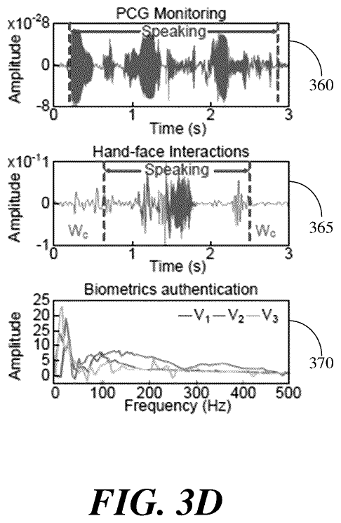

Among the diversified interferences to in-ear acoustic sensing applications, three typical ones are elected for further review, namely nodding (affecting ear canal resonances), walking (generating bone-conduction noise), and speaking (causing mixed interferences). As a baseline, a quasi-static sitting position is considered. The results are seen in the graphs of FIGS. 3A, 3B, 3C and 3D, wherein the graphs 300, 305, 310 of FIG. 3A depict the baseline sitting position for PCG monitoring, hand-face interactions and biometrics, respectively. The graphs 320, 325, 330 of FIG. 3B depict the effect of nodding on PCG monitoring, hand-face interactions and biometrics, respectively; the graphs 340, 345, 350 of FIG. 3C depict the effects of walking on PCG monitoring, hand-face interactions and biometrics, respectively; and the graphs 360, 365, 370 of FIG. 3D depict the effects of speaking on PCG monitoring, hand-face interactions and biometrics, respectively.

Firstly, PCG signal monitoring appears immune to nodding as seen in the graph 320 (comparable to sitting as seen in the graph 300), but speaking as seen in the graph 260 and walking as seen in the graph 340 largely overwhelm the heart sounds. Secondly, the hand-face interactions are similar to PCG, as nodding (graph 325) has minor impacts on the recorded signals but the other two activities (graph 345 for walking and graph 365 for speaking) can substantially contaminate the sensing results. Fortunately, these interferences and on-face interactions do not necessarily occur at the same time, hence they could be removed by straightforward time-domain filtering. Finally, biometric authentication would better be conducted under quasi-static (i.e., sitting) state as seen in the graph 310, because speaking (graph 370) significantly altered the acoustic spectrum below 200 Hz, while walking (graph 350) produces a wider range of interference from 10 Hz to 300 Hz.

It can thus be concluded that active sensing (i.e., biometric authentication) is sensitive to ear canal resonance noise while passive sensing (i.e., PCG monitoring and hand-face interaction analysis) may not be sensitive to such resonance noise. More prominently, as both sensing modes are sensitive to bone-conduction noise, addressing this interference is very critical for improving the sensing performance, but it is also very challenging as bone conduction noise often affects different applications in distinctive ways. For excitation signals occurring intermittently (e.g., hand-face interactions), noise might be eliminated by time-domain trimming, but continuous excitation signals (e.g., PCG) cannot be handled similarly. Given the wide frequency range of bone-conduction noise (covering frequencies from 0.5 Hz upward) that nullifies straightforward filtering, it is imperative to design advanced interference elimination methods.

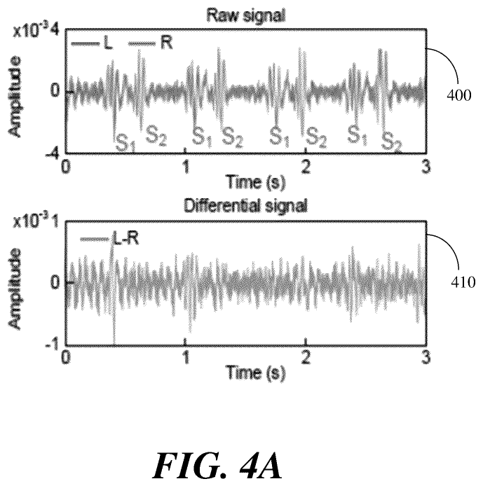

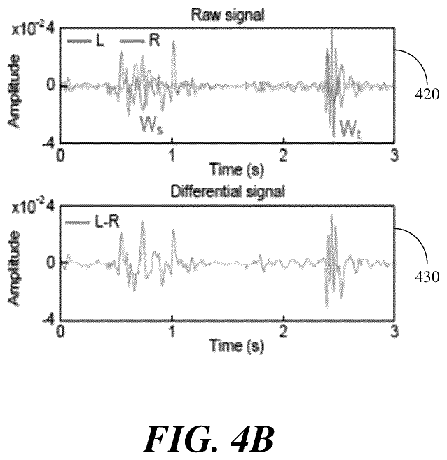

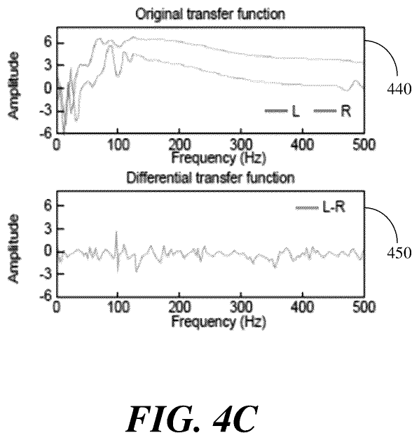

Due to the asymmetry of human bodies (e.g., bones, muscles, organs, and especially the two ears), the signals collected in each of the two ears are normally different. However, earphones are artificially made to be symmetric, so differential signals collected from both ears may remove system errors (or unknown system parameters) possessed by the earphones. Nonetheless, signal differences may not retain the features of the raw signals. Referring to FIGS. 4A, 4B and 4C, graphs depict two-ear signal difference in the acoustic sensing platform in accordance with the present embodiments in the three typical applications (FIG. 4A depicts PCG monitoring, FIG. 4B depicts hand-face interactions, and FIG. 4C depicts biometric authentication). In FIGS. 4A, 4B and 4C, the graphs 400, 420, 440 show signals collected from two ears (under the sitting state), while the differential signals are depicted in the graphs 410, 430 450. It can be clearly observed that, whereas differentiating PCGs (graph 410) and transfer functions (graph 450) results in a white-noise-like outcome, the hand-face interactions (graph 430) do seem to admit signal differentiation: the results share prominent features with the signals collected from the right ear when it was the righthand tapping/sliding on the face. As the acoustic sensing platform in accordance with the present embodiments directly uses commodity ANC microphones to collect acoustic signals, it needs not to exploit signal differentiation for removing unknown parameters. However, the positive case with hand-face interactions as shown in the graph 430 does offer us an inspiration to address this interference issue.

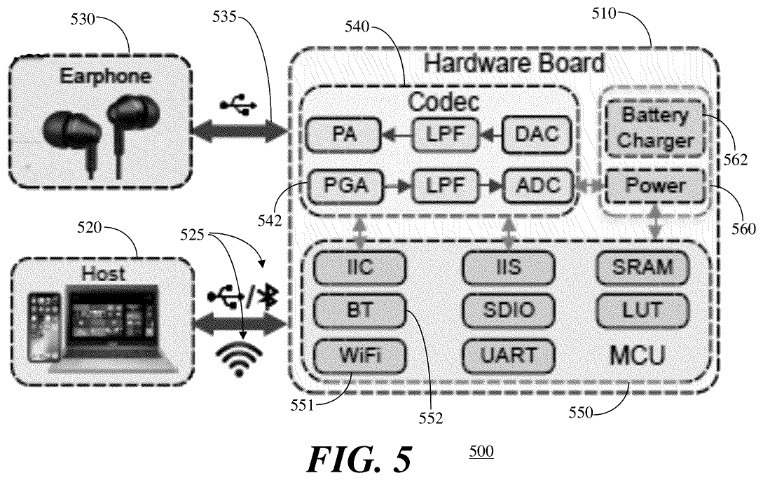

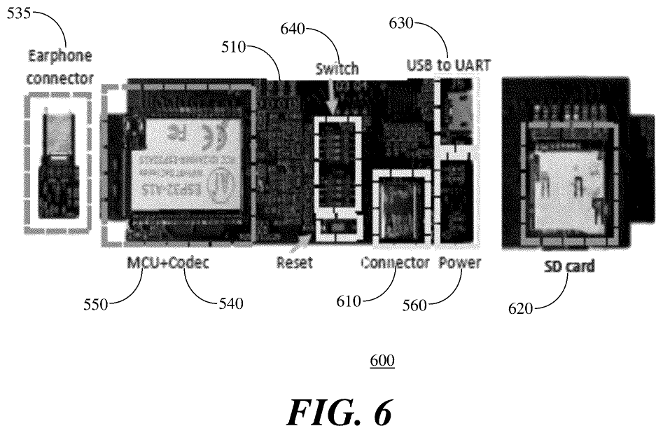

FIG. 5 depicts a diagram of the acoustic sensing platform 500 in accordance with the present embodiments and FIG. 6 depicts a photograph of an exemplary system 600 including the acoustic sensing platform 500 in accordance with the present embodiments. The acoustic sensing platform 500 in accordance with the present embodiments contains a sensing board 510 and a platform control interface on an arbitrary host 520 (e.g., an Android phone). It also involves two novel algorithms for ensuring robust acoustic sensing. While the sensing board can be readily attached to most ANC earphones 530 in a plugin manner, the control interface on the host 520 provides flexible tuning of hardware and sensing parameters. The sensing board 510 streams data to the host 520 in real time, and the data is processed by the sensing algorithms for profiling the DWSs and eliminating the body motion interference.

The sensing board 510 of the acoustic sensing platform in accordance with the present embodiments has a compact design but offers powerful processing capabilities and versatile compatibility with major ANC earphones 530. As shown in FIG. 5, the acoustic sensing platform in accordance with the present embodiments is built upon a stereo codec 540, such as an ES8388 codec with a configurable sampling rate ranging from 8 to 96 kHz and up to 24-bit resolution. The internal programmable gain amplifier (PGA) 542 should have a maximum 24 dB gain, adequate to accommodate microphones with heterogeneous sensitivity. The acoustic front-end (i.e., the earphones 530), including native multi-channel microphones and speakers, is routed to the codec 540 via a USB-C socket 535. The USB connector 535 is engineered to accommodate major analogue microphones, including electret condenser and microelectromechanical systems (MEMS) ones. Additionally, the signal pre-processing circuit is designed to be hardware-adaptive to native microphone heterogeneity, entailing only minor changes on resistors or capacitors. The codec 540 can be configured by an MCU via a serial interface 610 (FIG. 6).

In addition, a MCU 550, such as an ESP32 MCU, is used. The MCU 550 should be a feature-rich MCU with versatile connectivity and plentiful memory spaces as the core processor. The powerful MCU is meant to not only enable flexible configurations on the codec 540 but also deploy stand-alone real-time processing algorithms. To obtain convenient usability and accessibility, the MCU 550 is leveraged to also provide wireless connectivity 525 via either Wi-Fi 551 or Bluetooth 552 for remote processing. Thus, sensing results, raw audio samples, or configurations can all be streamed between the host 520 and the MCU 550 via the wireless links 525. To allow stand-alone continuous sampling of a huge volume of data, an auxiliary SD card slot is put on the hardware board to enable local data storage in a SD card 620. The UART port 630 is reserved for debugging and for experienced researchers to update or develop prioritized firmware. Other onboard resources include a power module 560 including a battery charger 562, a user button (on the bottom layer hence not shown in FIG. 6 due to space limitations), several reserved IOs for hardware extensions such as IMU units, and switches 640 for audio channel multiplexing. This design allows the acoustic sensing platform 510 in accordance with the present embodiments to emulate the full functionality of a potential sensing-ready ANC earphone 530, capable of offering insights for a future integrated product design.

The acoustic sensing platform in accordance with the present embodiments offers multiple approaches for platform control. One can access raw audio samples and playback arbitrary sounds in either stand-alone mode or remote mode, and both modes offer full functionality for configurations and sensing. In particular, the recorded channels can be manually configured by the switches 640 under both modes. The standalone mode requires no host support and is hence suitable for continuous sensing with negligible user interventions. One can start or stop the recording or playback processes via the user button under this mode. Given the wireless connectivity 525, a MATLAB script and an Android application enable remote configurations. The Android app allows for flexibly tuning microphone gain (via the PGA 542), adjusting the speaker volume, changing the sampling rate or bit resolution, etc. In addition to these essential settings, application-level configurations such as DWS profiling and ANC on-off switch are provided. For the MATLAB script running on PCs, these settings are listed in a readable JSON file and are synchronized to the sensing board 510 once a connection is established.

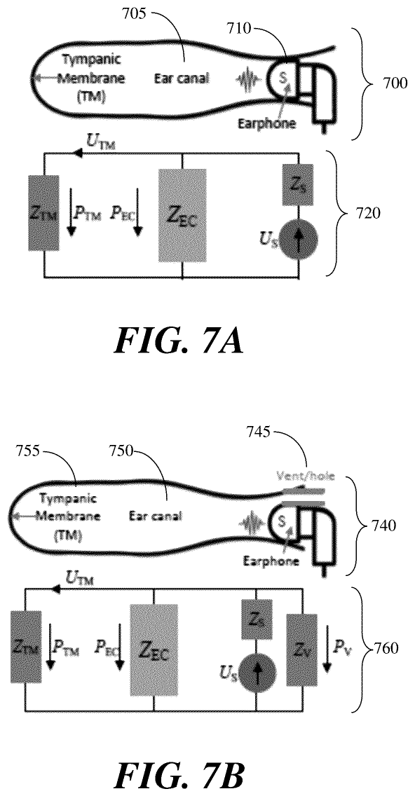

Profiling DWS across different users and earphones is crucial, yet it is inherently challenging as both ear canals and earphones have diverse structures. To qualitatively explain the effect of DWS on the acoustic characteristics of an ear canal, two configurations of an electro-acoustic model are utilized: namely perfect and partial occlusions distinguished respectively by the absence and presence of a vent at the ear canal entrance. Specifically, the ear canal is considered a cylindrical tube with varying radii under both cases. FIG. 7A depicts a diagram 700 and a schematic 720 of a perfect occlusion electro-acoustic model and FIG. 7B depicts a diagram 740 and a schematic 760 of a partial occlusion electro-acoustic model. For the perfect occlusion shown in FIG. 7A, the acoustic behavior can be modeled in the frequency domain as shown in Equation (1).

$$\frac{{P}_{EC}}{{Z}_{S} {U}_{S}} = \frac{{Z}_{EC}}{{Z}_{S} + {Z}_{EC}} \qquad ( 1 )$$

where P_{EC} is the sound pressure at the ear canal 705, Z_{EC} is the corresponding impedance at the ear canal 705, and U_{S} and Z_{S} are the source sound volume velocity and source impedance related to the Thevenin equivalent source sound pressure by P_{S}=U_{S}Z_{S}. As indicated in Equation (1), the Thevenin pressure P_{EC} is affected by both Z_{S} and Z_{EC}, where Z_{EC} is a varying factor under all perfectly occluded cases; Z_{EC} varies with the insertion depth of an occlusion device (e.g., the earphone 710).

For the partial occlusion shown in FIG. 7B, the presence of a vent 745 makes the earlier model insufficient. The vent 745 is modelled as a high-pass filter with impedance Z_{V} and sound pressure P_{V}, so that the total acoustic impedance of the ear canal 750 becomes the parallel of Z_{V} and Z_{EC} as shown in Equation (2).

$${Z}_{EC}^{′} = \frac{{Z}_{V} {Z}_{EC}}{{Z}_{V} + {Z}_{EC}} \qquad ( 2 )$$

Though the actual model for this case is far more complicated and less well studied, a simplified version can be obtained by replacing Z_{EC} in Equation (1) with Z′_{EC}. This allows one to conclude that the Thevenin pressure P_{EC} is a function of Z_{S}, Z_{EC,} and Z_{V}. Since Z_{V} can be approximated as a function of a radius of the vent 745 and the distance from the vent 745 to the tympanic membrane 755, as both the vent size and device insertion depth affect P_{EC}.

In short, the degree of occlusion (vent size) and the earphone insertion depth both affect the acoustic characteristics of an ear canal which highlights the necessity to profile DWS for acoustic sensing applications.

Profiling DWS demands quantitative characteristics, so we need an indicator correlated with the changes in DWS. Sound pressure and impedance are all affected by DWS variations, but their quantities (and their respective impacts from DWS) are physically very different. Yet, the impedance varies to a much greater extent than the pressure, even in a uniform tube and, especially, in the ear canal. Because the energy loss of acoustic signals due to propagation in the ear canal is very small, the sound pressures measured at the acoustic source, the eardrum, and the earphone (after reflected back) differ only by a barely detectable phase factor determined by the length of the ear canal.

Prior research and clinical audiometry have studied the ear canal impedance via many modalities, yet they are mostly inapplicable due to heavy user involvement or special hardware requirements. Accordingly, a simple yet effective solution has been developed for the acoustic sensing in accordance with the present embodiments. Given a sine sweep with bandwidth ranging from 0 Hz to 10 kHz sent into the ear canal as an excitation signal: the simultaneously recorded reflection signal can be used to figure out the frequency response within a wideband. The sound pressure P_{S} at the earphone can be obtained by the earphone and accounted by the sum of excitation sound pressure P_{S}⁺ and reflection sound pressure P_{S}⁻ and a complex reflectance coefficient is obtained as Γ=P_{S}⁻/P_{S}⁺. Assuming the ear canal area is of uniform area at the measurement point, the impedance Z_{EC} can be approximated by Equation (3).

$${Z}_{EC} = {z}_{0} \frac{1 + Γ}{1 - Γ} \qquad ( 3 )$$

The characteristic acoustic impedance z₀ is defined as z₀=cρ/A, where ρ is the density of air, c is the speed of sound, and A is the cross-sectional area at the measuring position. Variations due to the use of a slightly deviated area A to define z₀ are shown to have a minor effect on impedance measurements, so using the average area A₀ of an adult instead of the true area is sufficient. The involved parameters are summarized in Table 1.

TABLE 1

| Name | Constant | Value | Units |
|---|---|---|---|
| speed of sound | c | 33480 | cm/s |
| density of air | ρ | 0.001223 | g/cm³ |
| Average area of adult ear canal | A₀ | 0.442 | cm² |

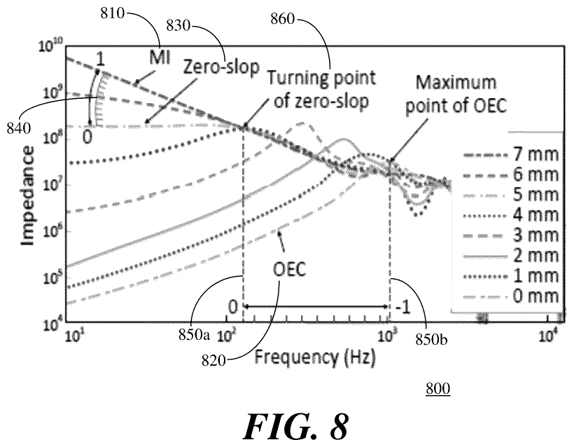

An example of how Z_{EC} of an adult varies with the depth of earphone insertion into the ear canal is depicted in graph 800 of FIG. 8. Under perfect occlusion (6 and 7 mm insert depth), the impedance is inversely proportional to frequency since the residual volume of the middle ear dominates the impedance. When the insertion depth decreases and the ear canal is only partially occluded by the earphone, a vent appears (as shown in FIG. 7B) and the impedance-frequency relation changes drastically. First, the amplitude drops significantly below around 100 Hz. Moreover, below a certain frequency, impedance becomes proportional to frequency, hence leading to a local maximum at higher frequencies, which explains the acoustic enhancement by the occlusion effect on such frequencies. For the open ear canal (0 mm insertion), the impedance seems to be proportional to the frequency component of up to around 1 kHz. In conclusion, as seen from the graph 800, the impedance under different device insertion depths and the degree of the ear canal occlusion clearly exhibit observable distinctions and, thus, is indicative of DWS.

Based on the impedance-depth relation, a systematic calibration procedure is presented for acoustic sensing in accordance with the present embodiments to capture the DWS for individual users. Specifically, a new user to the acoustic sensing platform in accordance with the present embodiments should slowly insert the earphone into his/her ear canal until no further insertion is possible (i.e., to the maximum distance). Meanwhile, the acoustic sensing platform in accordance with the present embodiments sends the swept signal repeatedly via the earphones and records the reflections. Consequently, multiple impedance-frequency trajectories are obtained, and those at the maximum insertion depth, when the device is barely inserted, and with a zero slope between 0 and 100 Hz (indicating the sudden turning from perfect to partial occlusion) are treated as three references and, as seen on the graph 800, are denoted by MI 810, OEC 820, and Zero-slop 830, respectively.

When in use for profiling, the impedance frequency trajectory for a given DWS is initially calculated. Then the instantaneous slope of the impedance trace at 100 Hz is used to characterize whether the ear canal is completely occluded, where a negative slope indicates a perfect occlusion and a positive slope indicates a partial occlusion. For perfect occlusions, we calculate the ratio of the slope of the current trajectory to the slope of the maximum insertion depth is calculated, both in the range 0-100 Hz, shown as the arc 840 with scales in the graph 800. A ratio closer to one indicates a deeper insertion depth. For partial occlusions, mapping the current insertion distance to a slope ratio may not be sufficiently robust. Therefore, a new indicator η is obtained whose scales are shown between the vertical dashed lines 850a, 850b in FIG. 8 and calculated as shown in Equation (4).

η=(f_{c}=f_{Zero-slop})/(f_{Zero-slot}−f_{OEC}) (4)

where f_{c} and f_{OEC} refer to the frequencies that respectively maximize the current impedance trajectory and the OEC trajectory, while f_{Zero-slop} denotes the turning point 860 of the Zero-slop trajectory. This DWS profiling method allows researchers to develop more efficient calibration algorithms and wearers to adjust their DWS in real time.

The acoustic characteristics exploited by the acoustic sensing platform in accordance with the present embodiments can be particularly susceptible to interference from body motions. Though removing such interference can be hard for conventional methods, we propose to leverage the different acoustic characteristics between left and right ears are leveraged in accordance with the acoustic sensing of the present embodiments to remove such interference.

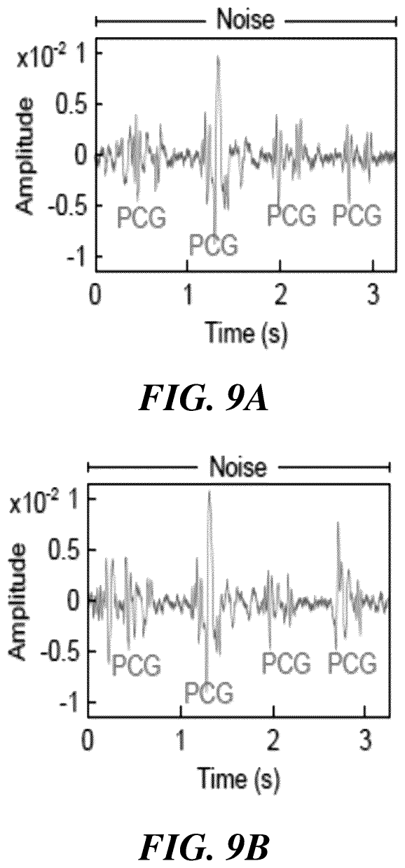

As the attenuation of sound propagation through bones and tissues is sensitive to the propagation path, the body motion interference acts differently to left and right ears due to body asymmetry. To demonstrate this asymmetry, we give an example of body motion interference on PCG signals collected from the two ears in FIGS. 9A and 9B, where FIG. 9A is a graph of body motion interference contaminating PCG signals in the left ear and FIG. 9B is a graph of body motion interference contaminating PCG signals in the right ear. While the interference always appears differently in the left and right ears, the interference intensity is typically less but can be higher than PCG intensity. Thus, the signals collected from each ear are mixtures of sensing target and body motion interference which the acoustic sensing platform in accordance with the present embodiments will extract a clean sensing target out of a noisy audio mixture.

In many applications, such as physiological signal monitoring and fitness exercise tracking, the sensing target is periodic or quasi-periodic, whereas the body motion interference is often non-periodic. Therefore, this contrast is exploited along with two-ear difference to extract the sensing target. Let y_{L}(t) and y_{R}(t) represent the in-ear audio signal collected from the left and right ears, which compose a signal vector y(t)={y_{L}(t), y_{R}(t)}. Assume a linear propagation channel for the source signal vector s(t) through bones and tissues to an ear canal, i.e., y(t)=As(t), with A being a mixing matrix. Accordingly, s(t)={s_{T}(t), s_{I}(t)} with s_{T}(t) and s_{I}(t) respectively represent the sensing target and body motion interference and a demixing matrix W needs to be determined such that s(t)=W^{T}y(t) separates the sensing target from the interference.

Since the sensing target is temporally correlated, but the body motion interference is not, they satisfy the relations for a nominal period shown in Equation (5).

$$\{ \begin{matrix}E [ {s}_{T} ( t ) {s}_{T} ( t - {ξ}^{*} ) ] & > 0 \\ E [ {s}_{T} ( t ) s \text{?} ( t - {ξ}^{*} ) ] = E [ s \text{?} ( t ) s \text{?} ( t - {ξ}^{*} ) ] & = 0\end{matrix} \qquad ( 5 )$$

$$\text{?} \text{indicates text missing or illegible when filed}$$

where [symbol] is the expectation operator. Then C(W) is defined as C(W)= [symbol] [s(t)s(t−ξ*)]=W^{T}E[y(t)y(t−ξ*)]W, where T refers to matrix transpose. Thanks to the symmetry of C(W), it can be further decomposed as shown in Equation (6).

$$C ( W ) = \frac{1}{2} C ( W ) + \frac{1}{2} {C ( W )}^{T} = \frac{1}{2} {W}^{T} ( {H}_{y} ( {ξ}^{*} ) + {{H}_{y} ( {ξ}^{*} )}^{T} ) W \qquad ( 6 )$$

where H_{y}(ξ*)= [symbol] [y(t)y(t−ξ*)^{T}]. The closer W projects y(t) on s(t), the larger the resulted value is, as projecting on s_{I}(t) leads to zero. Therefore, extracting s_{T}(t) implies maximizing C(W). Under the constraint that ∥W∥₂=1, the maximizing problem can be solved by finding the eigenvectors (denoted by [symbol] operator) of H_{y}(ξ*)+H_{y}(ξ*)^{T} as shown in Equation (7).

W= [symbol] (H_{y}(ξ*)+H_{y}(ξ*)^{T}) (7)

Then s_{T}(t)=w₁^{T}y(t) where w₁ is the eigenvector corresponding to the largest eigenvalue. This perfectly recovers s_{T}(t) if the nominal period is exact.

In reality, three practical issues should be considered. First, the nominal period ξ* generally does not exist. For example, the interbeat interval of heartbeats varies over time. To approximate ξ*, an autocorrelation method is used to obtain a mean period within a specified interval of interest. Second, the expectation of finite samples becomes a numerical average, leading to non-zero values for the uncorrelated signals in Equation (5). To avoid “leaking” s_{T}(t) onto other eigenvalues under imperfect conditions, the eigenvectors corresponding to the top-K eigenvalues in W are utilized, where K=3 may be set as the default value, but one can modify K according to specific applications.

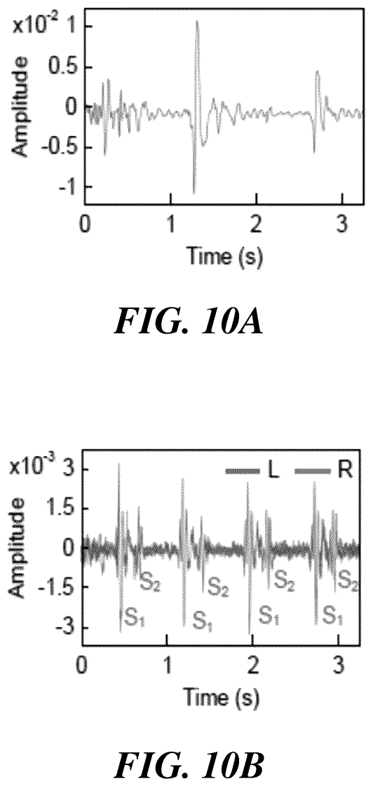

A further issue is that the above solution is based on the unrealistic assumption of a linear signal mixture model. Therefore, the demixed interference result is used as a reference and an adaptive filtering technique is applied for acoustic sensing in accordance with the present embodiments to obtain a clean sensing target. FIG. 10A shows an example of the demixed interference reference. Specifically, an adaptive step-size least mean squares (ASLMS) algorithm is applied to eliminate the interference of body motions. ASLMS can effectively handle the dynamic nature of most biological signals (i.e., nonstationary and change substantially in properties over time). Moreover, by updating the step size, it can work well at various interference levels. Consequently, combing the interference reference and the mixed signal at either ear, extract a clean sensing target can be extracted. The graph of FIG. 10B illustrates the extracted PCGs from both ears, clearly demonstrating the effectiveness of our overall method; note the scale difference between the graphs of FIGS. 10A and 10B.

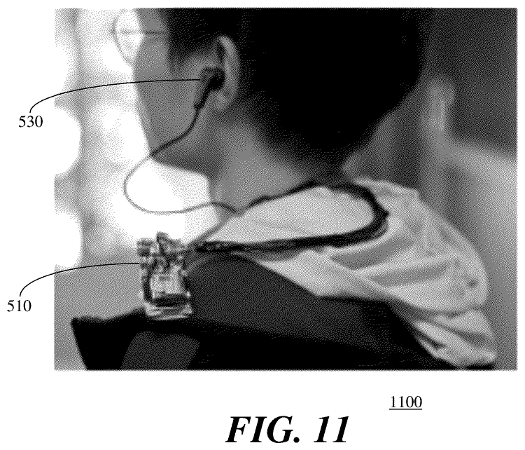

Due to its flexibility and robustness, the acoustic sensing platform in accordance with the present embodiments supports a wide range of potential applications covering both passive and active sensing. To demonstrate its efficacy and adaptability, full scale experiments on the three representative applications discussed hereinabove were conducted. In particular, performance under realistic settings were evaluated, where 35 subjects (20 male and 15 female, age between 20 to 50) and 50 pairs of ANC earphones with varying prices around $100 were involved. FIG. 11 depicts a photograph 1100 illustrating a subject wearing a prototype of the acoustic sensing platform 510 in accordance with the present embodiments connected to ANC earphones 530.

In accordance with a first experimental protocol, it was demonstrated that the acoustic sensing platform in accordance with the present embodiments can effectively collect PCG in the face of common body motions. Valvular and heart-related diseases have been a significant public health challenge and efficient disease evaluation and prevention calls for daily PCG monitoring since PCG monitoring provides an effective means of capturing clinically valued heart rate variability (HRV) features such as systolic period, diastolic period, and a standard deviation of interbeat intervals (SDNN). Therefore, the first experimental protocol advantageously showcased the extraction of these three parameters not achievable by existing earable sensing solutions.

For the first experimental protocol, each subject would wear the acoustic sensing platform prototype 510 in a manner as shown in the photograph 1100 with different earphones 530 for a PCG signal recording of five minutes. To study the system performance in practical scenarios, the subjects would rewear the earphones 530 for recordings while performing daily activities such as walking, making the bed, and cooking during the recording. The performing of daily activities allowed the collected data to include DWS variations and body motion interference. Meanwhile, the ground truth signals were obtained by an electrocardiogram (ECG) monitor. In practical operation, the acoustic sensing platform in accordance with the present embodiments first profiles the DWS to determine whether the ear canal is occluded to block external environment noise before applying the demixing algorithm discussed hereinabove to retrieve the PCG. In the experiments, the time periods with body motions were clearly marked in order to conduct comparative studies on the effectiveness of the acoustic sensing platform in accordance with the present embodiments. Moreover, to demonstrate the acoustic sensing platform's advantages over existing earphone-based platforms, the differential signal was extracted from the two ears and components above 50 Hz filtered out from signals sensed by the acoustic sensing platform in accordance with the present embodiments and two existing earphone-based platforms so as to set up comparative baselines. It was expected that such comparison would favor the existing platforms, as they rely on self-built earphone prototypes for sensing while the acoustic sensing platform in accordance with the present embodiments leverages native acoustics of well-engineered commodity products.

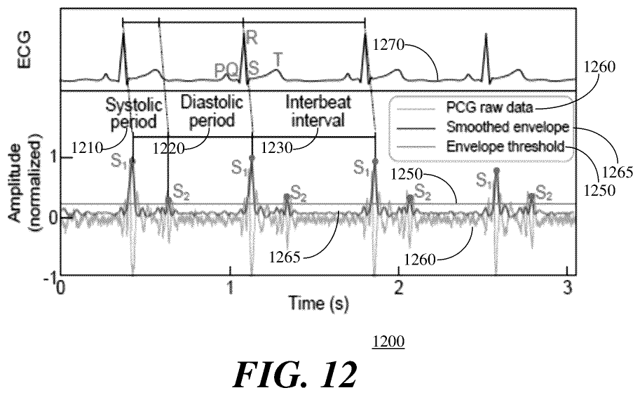

Prior to HRV features extraction, the acoustic sensing platform in accordance with the present embodiments identifies the major heart sounds S₁ and S₂ in the manner described hereinbefore. Since the periods of S₁ and S₂ exhibit significant fluctuation in the demixed signal while non-heart-sound periods are more stationary and lower in amplitude, the acoustic sensing platform in accordance with the present embodiments detects the major heart sounds S₁ and S₂ based on whether the demixed signal exceeds a certain threshold. Specifically, an average Shannon Energy envelope is computed as shown in Equation (8).

$${E}_{x} = \frac{1}{N} {\sum }_{t = 1}^{N} {x ( t )}^{2} \cdot log {x ( t )}^{2} \qquad ( 8 )$$

where x(t) is the normalized signal in the range of [−1, 1] and N is a window size usually set to 0.02 seconds with 0.01 second overlapping. Then a smoothed envelope is obtained by applying zero-phase filtering on the envelope and the peaks of S1 and S2 are identified as Eₓ exceeding an empirically set threshold value of 0.2. Alternatively, an adaptive threshold value can be developed based on variables of the system or based on the measured PCG signals. The systolic period 1210, the diastolic period 1220, and the interbeat intervals 1230 are extracted based on the peaks exceeding the threshold 1250 as shown in the graph 1200 of FIG. 12. The graph 1200 also illustrates the alignment between the PCG signal 1260 and the filtered smooth envelope 1265 with the corresponding ECG signal 1270. It can be observed that the QRS complex and T wave of the ECG signal 1270 are temporally aligned with features of the PCG signal 1260. Therefore, the ECG signal 1270 is used to derive the ground truth for the HRV features so as to validate the quality of the PCG signals 1260 retrieved by the acoustic sensing platform in accordance with the present embodiments.

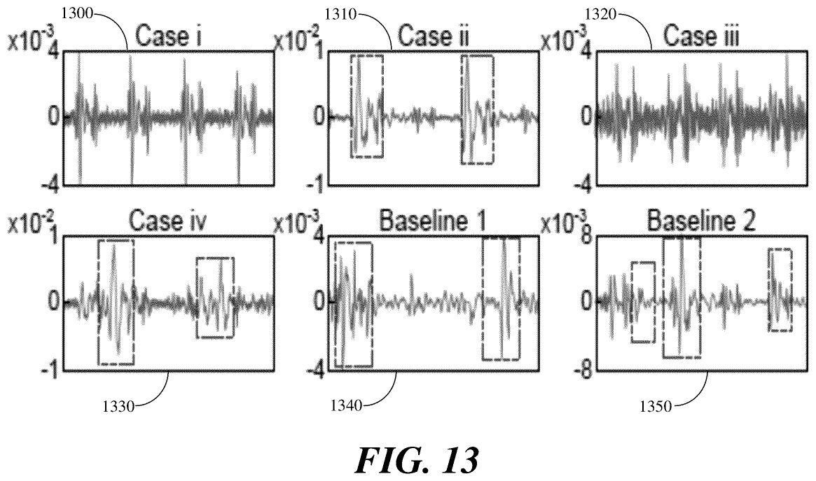

As discussed hereinbefore, PCG signals can be affected by DWS and body motion interference. To demonstrate the acoustic sensing platform in accordance with the present embodiments can well handle these practical situations, we group the data is grouped according to whether the earphones completely occlude (as represented by CO∈{0, 1}) the left ear canal (indicated by DWS profile) and whether the body motion interference elimination method of the acoustic sensing in accordance with the present embodiments is deployed (as represented by IE∈{0, 1}). Specifically, four cases are studied and snapshots of the four cases and two baselines are shown in the graphs of FIG. 13. A graph 1300 shows a “case i” where CO=1 and IE=1. A graph 1310 shows a “case ii” where CO=1 and IE=0. A graph 1320 shows a “case iii” where CO=0 and IE=1. And a graph 1330 shows a “case iv” where CO=0 and IE=0. Two implementations of existing PCG acoustic sensing are shown in a graph 1340 (“Baseline1”) and a graph 1350 (“Baseline2”).

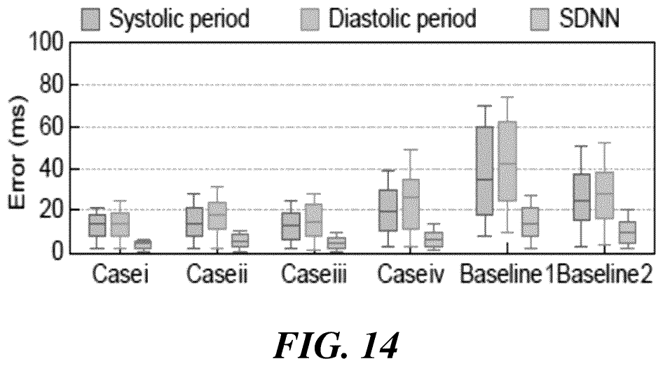

Referring to FIG. 14, a box plot of the systolic period, diastolic period, and standard deviation of normal-to-normal (SDNN) of the R-R intervals in each of the four cases and the baselines depicted in the graphs 1300 to 1350 in FIG. 13. One can readily observe that all four cases surpass the two baselines. This indeed conforms to the observation that the acoustic sensing platform in accordance with the present embodiments is beneficial for sensing applications by retaining original information, rather than deducing differential signals from two ears or being confined to a limited frequency range. Moreover, “Case i” achieves the lowest error for all HRV features as expected since the earphone completely occludes the ear canal and the body motion interference elimination method of the acoustic sensing in accordance with the present embodiments is deployed. Specifically, the three features receive respective median errors of 14.31 ms (4.77% of the 300 ms nominal systolic period), 14.74 ms (2.95% of the 500 ms nominal diastolic period), and 5.35 ms. These results confirm the efficacy of the acoustic sensing platform in accordance with the present embodiments in obtaining accurate HRV estimations. Finally, other cases exhibit higher error compared against “Case I” indicating that the DWS profiling and interference elimination are necessary and effective, while the error of “Case iii” being a bit smaller than that of the error of “Case ii” suggests that the proposed body motion interference elimination algorithm may handle a broader range of interference (e.g., interference from the external environment) beyond just body motions.

Next, the usefulness of the acoustic sensing platform in accordance with the present embodiments is showcased by considering an application of detecting multiple hand-face interactive gestures. Note that the acoustic sensing platform in accordance with the present embodiments is readily applicable to other behavior analysis applications such as eating habit analysis and facial expression monitoring in addition to hand-face interactive gestures. The hand-face interactive gestures are selected for presentation herein and this appears to be one of the most popular earable sensing tasks in recent studies.

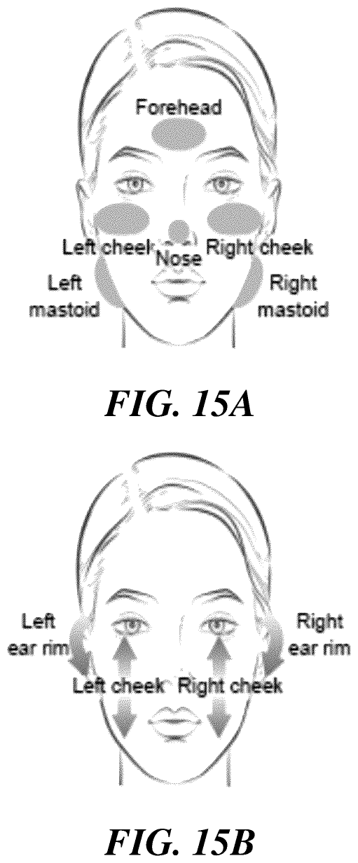

Referring to the illustrations of FIGS. 15A and 15B, six tapping gestures (FIG. 15A) and six sliding gestures (FIG. 15B) associating different face positions and actions are considered to test the hand-face interactive gesture efficacy of the acoustic sensing platform in accordance with the present embodiments. The gesture set studied by the acoustic sensing platform in accordance with the present embodiments is one of the largest of its kind considered by earphone-based platforms. Subjects are asked to respectively perform these gestures while wearing the prototype of the acoustic sensing platform in accordance with the present embodiments. Each subject repeats every gesture fifty times using a different pair of earphones each time to include small variations in devices. In total, 21,000 gestures were collected for evaluation, each gesture collected under perfect ear canal occlusion and minimal body motions as it is believed that DWS barely affects the features of the acquired signals and the body motion interference should usually be avoided for applications using hand-face interaction as a control interface. Therefore, the discriminability of the gesture-induced signals collected by the acoustic sensing platform in accordance with the present embodiments was evaluated under a normal DWS and absent other unnecessary body motions such as walking or exercising.

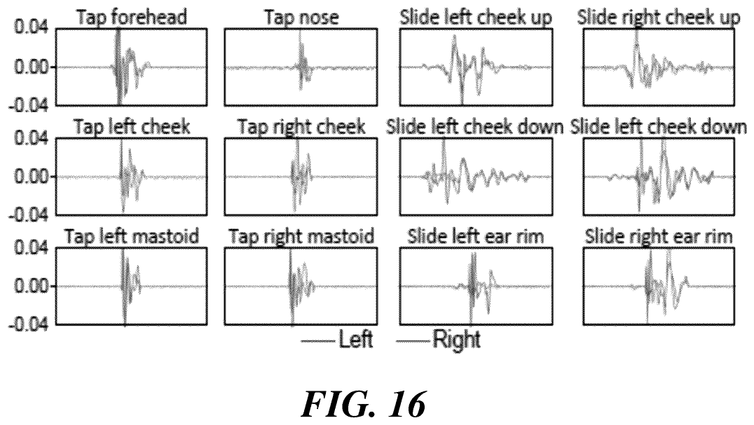

Interaction gesture analysis involves detection and classification. The acoustic sensing platform in accordance with the present embodiments first performs gesture detection to check the presence of a gesture based on the observation that the short-term energy (STE) introduced by a hand-face gesture is significantly higher than that of system noise. Specifically, the STE of sensed signal x(m) is retrieved as shown in Equation (9).

$${STE}_{n} = {\sum }_{m = n - N + 1}^{n} {[ x ( m ) ω ( n - m ) ]}^{2} , n - N + 1 \leq m \leq n \qquad ( 9 )$$

where w(n−m) is a window, N is the window length, and n represents the last sample that the window targets. The acoustic sensing platform in accordance with the present embodiments adopts a threshold to judge the presence of a gesture by whether STET, goes beyond the threshold. The window is empirically set to be rectangular with a 30 ms length and the threshold is set to be twice of the average STET, computed adaptively from the past 100 ms. FIG. 16 depicts gesture-induced waveforms of exemplary detection of each of the six tapping gestures and each of the six sliding gestures.

Upon detecting a gesture, features from both time and frequency domains, including gesture duration, the main frequency of the signal envelope, the root-mean-square energy, spectral centroid, zero-crossing rate, the first thirteen components of Mel-frequency cepstral coefficients (MFCC), and the temporal differential of the MFCC, are extracted for further classification. The features from both left and right channels are combined into a feature vector and input into a classifier. In addition to the twelve gesture classes, there is a NULL class to avoid classifying interference, such as unexpected body motions, as gestures. In the experiments, the collected data is split into 80% training data and 20% testing data. Given the diverse methods available for classification, the performance of recognizing hand-face interaction gestures is evaluated with four commonly used classifiers: random forest (RF), decision tree (DT), k-nearest neighbors (kNN), and support vector machine (SVM).

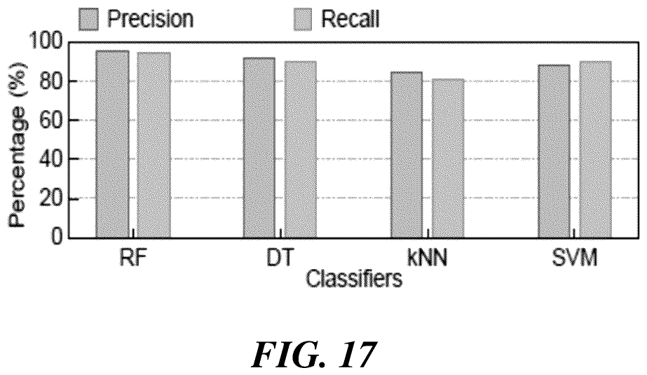

A five-fold cross-validation on the collected data was conducted and the bar graph of FIG. 17 compares the performance of different classifiers (random forest (RF), decision tree (DT), k-nearest neighbors (kNN), support vector machine (SVM)) in terms of precision and recall. It can be noted that all classifiers achieve precision and recall over 80% with the features. In particular, the RF classifier achieves 96.39% precision and 94.69% recall, rendering a trial with popular deep neural networks redundant. Overall, the results confirm the effectiveness of the acoustic sensing platform in accordance with the present embodiments in collecting fine-grained and hence highly discriminable gesture-induced signals suitable for virtually any classifiers.

The acoustic sensing platform in accordance with the present embodiments is not only capable of performing passive sensing to acquire physiological signals and body activities, but can also actively probe the ear canal structure. Thus, the performance of the acoustic sensing platform in accordance with the present embodiments is studied for continuous authentication, leveraging a piece of music reflected by the ear canal structure as each ear canal internal structure is unique to an individual.

For active sensing for continuous authentication, each subject wore the acoustic sensing platform in accordance with the present embodiments while listening to a clip of Johann Pachelbel's Canon in D Major for five sessions, each session lasting for thirty seconds and divided into fifteen non-overlapping recordings having a length of two seconds. This excitation signal was arbitrarily chosen as any clips without silent intervals can serve as candidates. The subjects were asked to rewear the earphones so that each session is conducted under a different DWS. Similar to the previous application, unnecessary body motions are minimized to emulate a realistic application scenario. In total, 2,625 two-second recording samples were obtained for evaluation. The experiments were designed to demonstrate that user authentication can be achieved by the transfer function that uniquely characterizes the ear canal structure of a certain user.

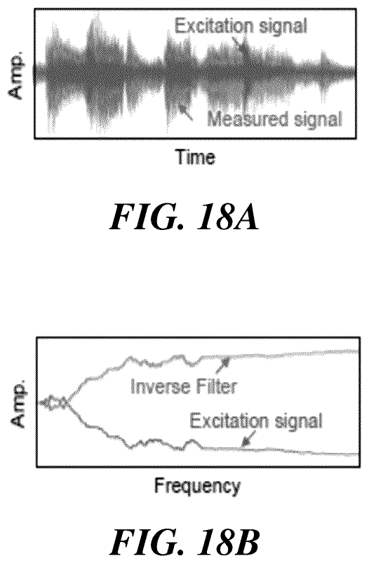

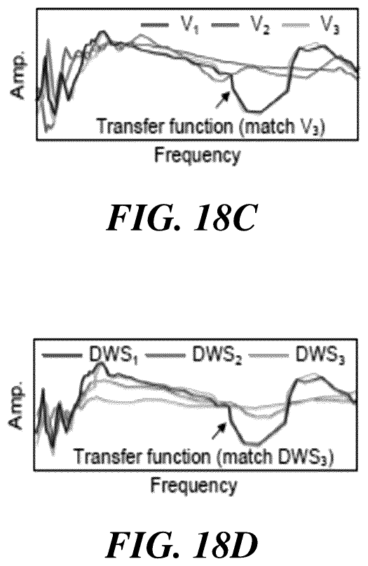

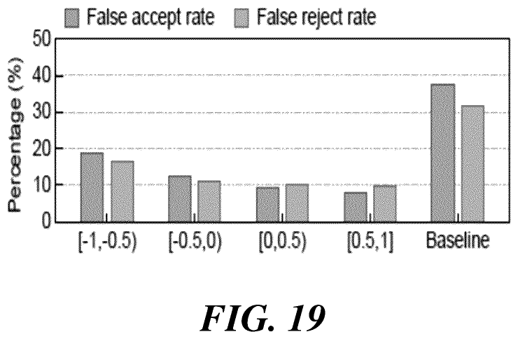

Basically, the earphone, ear canal, and eardrum together are considered as a black box system, and the transfer function characterizing it may not be sufficiently unique if obtained assuming linearity and time-invariance. Therefore, a more complex yet practical system model was considered involving nonlinearity and memorylessness, as illustrated in FIGS. 18A, 18B, 18C and 18D. Inside the system, the excitation signal sₑ(t) in FIG. 18A first passes through a memoryless nonlinear distorter characterized by a n-th order Volterra kernel kₙ(t), and then reverberated through a linear filter f(t). In the meantime, certain noise n(t) can be involved and added to the measured signal sₘ(t) in FIG. 18A as shown in Equation (10).

$$\begin{matrix}{s}_{m} ( t ) = n ( t ) + {s}_{e} ( t ) ⊗ {k}_{1} ( t ) ⊗ ℓ ( t ) + … + {s}_{e}^{n} ( t ) ⊗ {k}_{n} ( t ) ⊗ ℓ ( t ) \\ = n ( t ) + {s}_{e} ( t ) ⊗ ℓ ( t ) + … + {s}_{e}^{n} ( t ) ⊗ ℓ ( t )\end{matrix}$$

where the convolution ⊗ between nonlinear distortion kₙ(t) and linear reverberation l(t) is replaced by [symbol] ₙ(t). This essentially describes the transfer process by a set of impulse responses, each of them being convolved with a distinct power of the excitation signal.

The noise n(t) is resolved by taking a number of synchronous averages to sₘ(t). Since deconvolving using Fast Fourier Transformation usually leads to time aliasing artifacts, an inverse filtered signal g(t) is generated which inverts the response of the excitation signal in FIG. 18B. This process allows one to derive a transfer function by integrating the averaged output ŝₘ(t) and inverse filtered signals g(t) in the frequency domain. As discussed hereinbefore, the transfer function trajectories of different subjects have unique and stable variation patterns and exhibit discernible differences mostly over the range of [0, 50] Hz and [300, 500] Hz. Therefore, a dynamic time warping (DTW) based similarity matching scheme is employed to classify a given user based on the transfer function in the range of [0-500] Hz. Specifically, in the registration phase, a user's transfer function is recorded as his/her template. Upon authenticating a user, we look for the best similarity matching between the current user's transfer function and the stored templates is looked for. The user is authenticated if the matched template corresponds to whom he/she claims to be, as shown by FIG. 18C; otherwise, the authentication fails. In addition, the transfer function varies with DWS even for the same user, so the acoustic sensing platform in accordance with the present embodiments profiles DWS with the indicator η to accurately identify a user, as shown in FIG. 18D.

Thus, the performance of the acoustic sensing platform in accordance with the present embodiments in authentication is evaluated, and in particular, we look into the influence of the DWS on authentication is investigated. The measured signals are grouped into four datasets according to the DWS indicator η, namely [−1, −0.5], [−0.5, 0], [0, 0.5], and [0.5, 1]. The template set and the test set are disjointly selected from the dataset with 2,625 samples, with the template set accounting for 60% and the test set 40%. Moreover, the case is considered where all collected data are blended without DWS differentiation as the baseline, which represents earlier proposals that do not consider DWS. FIG. 19 is a bar graph which compares the false accept rate (the probability that a different user is wrongly authenticated as a given user) and the false reject rate (the probability that a legitimate user is not authenticated) of the four groups and a baseline. It is noted that all four groups achieve reasonable results, where the false accept rates and false reject rates of [0, 0.5] and [0.5, 1] group are all below 10%, confirming the advantageous capability of the acoustic sensing platform in accordance with the present embodiments in authenticating users. Moreover, it is observed that all four groups significantly outperform the baseline, firmly demonstrating that the DWS profiling method is critical to ensure a reasonable performance of user authentication.

As discussed herein, a fast and effective method to eliminate non-periodic motion interference for a periodic sensing target has been proposed. If the periodicity of the target is inconspicuous, motion interference elimination may be achieved using the novel blind source separation method leveraging signals collected from left and right ears. In regards to operation of the acoustic sensing platform in accordance with the present embodiments under different levels of ambient noise, it is noted that ANC earphones integrate inverse filters to perform noise cancellation which greatly reduce environment noise by adding them to the acquired signals. However, fully integrating the sensing ability of the acoustic sensing platform in accordance with the present embodiments with noise cancellation can improve its operation under different levels of ambient noise.

While three exemplary applications of the acoustic sensing platform in accordance with the present embodiments have been discussed herein, the acoustic sensing platform in accordance with the present embodiments is not limited to these three applications. It is contemplated that the design and platform can support multiple applications, even multiple applications running concurrently and potentially with specifically designed signal waveforms.

It is noted that the audio quality of music playback is not affected by the operation of the acoustic sensing platform in accordance with the present embodiments as it's plug-in design does not affect the internal structure and circuits of earphones. In fact, all test subjects indicated that the operation of the acoustic sensing platform in accordance with the present embodiments did not affect the music quality and agreed that no difference from normal earphone operation was perceived when attaching the acoustic sensing platform in accordance with the present embodiments.

Thus, it can be seen that the present embodiments provide an acoustic sensing platform in accordance with the present embodiments which leverages commercial ANC earphones and their native acoustics for enabling versatile sensing applications. The present embodiments provide a system design which efficiently addresses characteristics and affecting factors of acoustic signals across three major human sensing categories. Consequently, the acoustic sensing platform in accordance with the present embodiments provides flexible yet powerful hardware control and two critical functions to ensure reliable measurements, which has maximized the sensing capability for diversified applications and lowered the development barrier for novice researchers. The results of the operation of the acoustic sensing platform in accordance with the present embodiments discussed herein demonstrate the advantageous capability of the acoustic sensing platform in accordance with the present embodiments in sensing abundant information across human physiological signals, behaviors, and biometrics.

While exemplary embodiments have been presented in the foregoing detailed description of the present embodiments, it should be appreciated that a vast number of variations exist. It should further be appreciated that the exemplary embodiments are only examples, and are not intended to limit the scope, applicability, operation, or configuration of the invention in any way. Rather, the foregoing detailed description will provide those skilled in the art with a convenient road map for implementing exemplary embodiments of the invention, it being understood that various changes may be made in the function and arrangement of steps and method of operation described in the exemplary embodiments without departing from the scope of the invention as set forth in the appended claims.

What is claimed is:

1. An acoustic sensing system comprising:
an acoustic sensing controller configured to receive signals from an active noise cancellation earphone device, wherein the acoustic sensing controller is further configured to process the signals to determine device wearing status acoustic characteristics and actively correct the signals in response to the device wearing status acoustic characteristics, and wherein the device wearing status acoustic characteristics include ear canal occlusion.

2. The acoustic sensing system in accordance with claim 1, wherein the sensing controller is further configured to detect body motion interference and further process the signals to actively correct the signals in response to the body motion interference detected.

3. The acoustic sensing system in accordance with claim 2, wherein the sensing controller is configured to further process the signals to actively correct the signals in response to the body motion interference detected by demixing body motion interference signals in response to a non-periodic content of the body motion interference signals.

4. The acoustic sensing system in accordance with claim 1, wherein the acoustic sensing controller is configured to determine the device wearing status acoustic characteristics by profiling a device wearing status of the active noise cancellation earphone device, and wherein the acoustic sensing controller is configured to process the signals received from the active noise cancellation earphone device to actively correct the signals for device wearing status acoustic characteristic in response to the profiled device wearing status.

5. The acoustic sensing system in accordance with claim 4, wherein the acoustic sensing controller is configured to generate acoustic correction signals in response to the device wearing status profile, and wherein the acoustic sensing controller is further configured to send the acoustic correction signals to the active noise cancellation earphone device for real time adjustment of acoustic output from the active noise cancellation earphone device.

6. The acoustic sensing system in accordance with claim 5, further comprising an information storage device coupled to the acoustic sensing controller, and wherein the acoustic sensing controller is configured to profile the device wearing status of the active noise cancellation earphone device by measuring and storing in the information storage device a plurality of profiles of device wearing status acoustic characteristics, and wherein the acoustic sensing controller is configured to generate the acoustic correction signals in response to one or more of the plurality of profiles of device wearing status acoustic characteristics.

7. The acoustic sensing system in accordance with claim 1, wherein the acoustic sensing controller is further configured to process the signals to determine biometric measurements including one or more of respiration rate and heartbeat.

8. The acoustic sensing system in accordance with claim 7, wherein the biometric measurements further include phonocardiogram measurements.

9. The acoustic sensing system in accordance with claim 1, wherein the acoustic sensing controller is configured to generate acoustic signals for determining ear canal biometrics, and wherein the acoustic sensing controller is further configured to cause the acoustic signals to be broadcast within a user's ear canal and monitor output of the active noise cancellation earphone device to determine an earprint for authentication of the user.

10. The acoustic sensing system in accordance with claim 1, further comprising the active noise cancellation earphone device, and wherein the acoustic sensing controller is configured to adapt to acoustic characteristics of the active noise cancellation earphone device.

11. The acoustic sensing system in accordance with claim 10, wherein the acoustic noise cancellation earphone device comprises native acoustics, and wherein the acoustic sensing controller is configured to receive signals from the native acoustics of the active noise cancellation earphone device, and wherein the acoustic sensing controller is further configured to process the signals from the native acoustics of the active noise cancellation earphone device to determine the device wearing status acoustic characteristics.

12. A method for acoustic sensing comprising:
receiving signals from an active noise cancellation earphone device;
processing the signals to determine device wearing status acoustic characteristics; and
actively correcting the signals in response to the device wearing status acoustic characteristics, wherein the device wearing status acoustic characteristics include ear canal occlusion by the active noise cancellation earphone device.

13. The method in accordance with claim 12, further comprising:
detecting body motion interference; and
further processing the signals to actively correct the signals in response to the body motion interference detected.

14. The method in accordance with claim 13, wherein processing the signals to actively correct the signals in response to the body motion interference detected comprises processing the signals to actively correct the signals in response to the body motion interference detected by demixing body motion interference signals in response to a non-periodic content of the body motion interference signals.

15. The method in accordance with claim 12, wherein processing the signals to determine device wearing status acoustic characteristics comprises determining the device wearing status acoustic characteristics by profiling a device wearing status of the active noise cancellation earphone device, and
wherein actively correcting the signals in response to the device wearing status acoustic characteristics comprises processing the signals received from the active noise cancellation earphone device to actively correct the signals for device wearing status acoustic characteristic in response to the profiled device wearing status.

16. The method in accordance with claim 15, wherein processing the signals received from the active noise cancellation earphone device to actively correct the signals for device wearing status acoustic characteristic comprises:
generating acoustic correction signals in response to the device wearing status profile; and
sending the acoustic correction signals to the active noise cancellation earphone device for real time adjustment of acoustic output from the active noise cancellation earphone device.

17. The method in accordance with claim 16, wherein profiling the device wearing status of the active noise cancellation earphone device comprises profiling the device wearing status of the active noise cancellation earphone device by measuring and storing a plurality of profiles of device wearing status acoustic characteristics, and
wherein generating the acoustic correction signals in response to the device wearing status profile comprises generating the acoustic correction signals in response to one or more of the plurality of profiles of device wearing status acoustic characteristics.

18. The method in accordance with claim 12, further comprising processing the signals to determine biometric measurements including one or more of respiration rate, heartbeat and phonocardiogram measurements.

19. The method in accordance with claim 12, further comprising:
generating acoustic signals for determining ear canal biometrics;
broadcasting the acoustic signals within a user's ear canal; and
monitoring output of the active noise cancellation earphone device to determine an earprint of the user's ear canal for authentication of the user.

20. A non-transitory computer readable medium having stored thereon software instructions that, when executed by a processor, cause the processor to:
process signals received from an active noise cancellation earphone device to determine device wearing status acoustic characteristics; and
actively correct the signals in response to the device wearing status acoustic characteristics, wherein the device wearing status acoustic characteristics include ear canal occlusion by the active noise cancellation earphone device.
